(19) United States
(12) Patent Application Publication
(10) Pub. No.: US 2026/0184292 A1
(43) Pub. Date: Jul. 2, 2026

(54) WHEEL BRAKE MODULE OF A BRAKE SYSTEM OF A MOTOR VEHICLE, BRAKE SYSTEM, MOTOR VEHICLE

(71) Applicant: Robert Bosch GmbH, Stuttgart (DE)

(72) Inventor: Matthias Greiner, Simmozheim (DE)

(21) Appl. No.: 19/130,138

(22) PCT Filed: Feb. 16, 2024
(86) PCT No.: PCT/EP2024/053987

§ 371 Date: May 15, 2025

(30) Foreign Application Priority Data
Feb. 23, 2023 (DE) 10 2023 201 672.9

(51) Int. Cl. B60T 13/74; B60T 13/16; F16D 55/226; F16D 65/18; F16D 121/04; F16D 121/24; F16D 125/40; F16D 125/50; F16D 125/60

(52) U.S. Cl. CPC B60T 13/745; B60T 13/168; F16D 55/226; F16D 65/18; F16D 2121/04; F16D 2121/24; F16D 2125/40; F16D 2125/50; F16D 2125/60

(57) ABSTRACT

A wheel brake module of a brake system of a motor vehicle. The wheel brake module has an actuatable wheel brake device for decelerating the motor vehicle, and a controllable electromechanical brake force generator. The brake force generator is configured to feed hydraulic fluid into a hydraulic brake circuit in order to generate brake pressure at the wheel brake device. The wheel brake module includes the hydraulic brake circuit as a hydraulically closed brake circuit such that the brake circuit is assigned only to the wheel brake module.

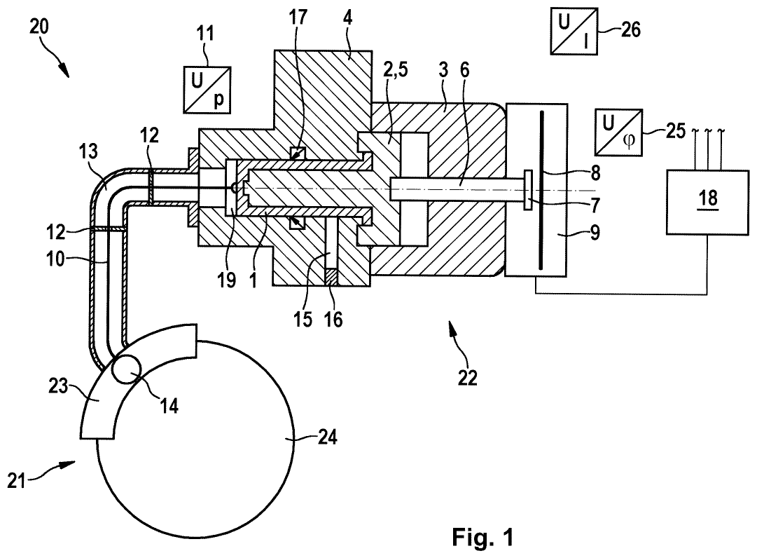

### FIELD

The present invention relates to a wheel brake module of a brake system of a motor vehicle, with an, in particular exactly one, actuatable wheel brake device for decelerating the motor vehicle, and with an, in particular exactly one, controllable electromechanical brake force generator, wherein the brake force generator is designed to feed hydraulic fluid into a hydraulic brake circuit in order to generate brake pressure at the wheel brake device.

In addition, the present invention relates to a brake system with at least one such wheel brake module and to a motor vehicle of such a brake system.

### BACKGROUND INFORMATION

Wheel brake modules of the type mentioned at the outset are described in the related art. For example, Germany Patent Application No. DE 10 2010 044 501 A1 describes a hydraulic brake system for a motor vehicle with at least four wheels, which provides a separate electromechanical brake booster with a hydraulic control unit at least for each axle, in particular for each wheel. In particular, a common electromechanical brake booster is provided for the two wheels of the front axle, and a separate brake booster is provided for each of the two rear wheels, or each wheel is assigned its own brake, which can in each case be supplied with hydraulic brake fluid by means of its own electromechanical brake booster. A common pump is provided for this purpose.

Purely electromechanical wheel brake modules are also described in the related art. For example, Germany Patent Application No. DE 10 2004 009 469 A1 describes a brake control system for a vehicle, with a service brake comprising an electronically controllable brake unit for brake actuation for each of the at least four wheels of the vehicle. In particular, each of the brake units has a separate brake actuator, wherein the brake units are in particular electromechanical brake units and comprise an electric motor as an actuator, which, when actuated, presses conventional brake shoes onto a conventional brake disk. A four-circuit brake system without hydraulic lines is to be realized in this way.

### SUMMARY

A wheel brake module according to the present invention module comprises a hydraulic brake circuit as a hydraulically closed brake circuit such that the brake circuit is assigned only to the wheel brake module. Due to the design of the wheel brake module according to the present invention, a separate, independent brake circuit is assigned to a corresponding wheel of the motor vehicle. The wheel brake module does not require an external hydraulic connection. If multiple wheel brake modules are provided, in particular one for each wheel of the motor vehicle, they are in particular only electrically connected to a higher-level control logic for controlling but are not hydraulically connected to one another. This has the advantage that the brake system has a modular structure and can be pre-assembled independently of the assembly of the motor vehicle. In particular, the usual filling of a hydraulic vehicle-wide brake circuit is omitted, which otherwise can only be carried out after complete assembly of the brake system because the wheel brake modules represent hydraulically closed systems and are thus already advantageously filled beforehand. In particular, the wheel brake modules each have a one-time service-life hydraulic oil filling. In this respect, the wheel brake module constitutes an advantageous alternative to the conventional wheel brake modules mentioned at the outset, which have a separate brake force generator for each wheel but are still hydraulically connected to one another via a common pump, in particular draw from a common brake fluid reservoir. In addition, the wheel brake module constitutes an alternative to the conventional purely electromechanical wheel brake modules mentioned at the outset, because the hydraulic ratios inherent in the hydraulic system can still be used, for example through an advantageous surface ratio between a piston surface of the brake force generator and a brake caliper of the wheel brake device, which allows simple hydraulic force transmission and force increase. The actuators used to control the brake force generators require lower power in comparison to the high-power electric motors used in the electromechanical wheel brake modules and are compact and cost-effective. For example, an electric motor with a torque of less than 1 Nm is sufficient.

According to a preferred development of the present invention, it is provided that the brake force generator comprises a first hydraulic piston, that the wheel brake device comprises at least a second hydraulic piston, and that a surface ratio of an end face of the second hydraulic piston to the first hydraulic piston is at least 3 to 1, 5 to 1, or 10 to 1. The brake force generator thus has a particularly advantageous hydraulic ratio. For example, a diameter of the first hydraulic piston is in a range of 8 mm to 15 mm, and/or a diameter of the second hydraulic piston is in a range of 28 mm to 36 mm when using a fixed caliper or 36 mm to 66 mm when using a single-piston floating caliper, or the diameters of the second and a third hydraulic piston are each in a range of 42 mm to 70 mm when using a two-piston floating caliper. The volume of the hydraulic piston is in particular in a range of 1 cm³ to 5cm³ , wherein the piston stroke is between 20 mm and 60 mm, for example. Due to the low piston diameter, the axial forces on the components of the brake force generator are low, which makes cost-effective materials, in particular plastics, and relatively loose tolerances on the components possible. Nevertheless, due to the advantageous surface ratio, it is ensured that a clamping force of, for example, 45 kN necessary at the wheel brake device between the brake disk and the brake caliper is safely achieved.

Particularly preferably, according to an example embodiment of the present invention, it is provided that a first actuating element of the brake force generator and a second actuating element of the wheel brake device are operatively connected to one another by a connecting element such that the wheel brake device is not actuated in a rest position of the first actuating element. Such an arrangement advantageously ensures that the wheel brake device is not actuated unintentionally. In this respect, the connecting element serves as a type of advantageous automatic return element, i.e., provides for active retraction, so that, for example, there is no longer any contact between a brake pad and a brake disk of the wheel brake device in a rest position of a hydraulic piston of the brake force generator.

According to a preferred development of the present invention, it is provided that the connecting element is designed as a pull cable, in particular a plastic-coated metal cable, in particular a Bowden cable. The design as a pull cable creates a particularly robust and simple way to reset the wheel brake device.

Particularly preferably, according to an example embodiment of the present invention, it is provided that the first actuating element is designed as a first hydraulic piston. The design of the first actuating element as a hydraulic piston has the advantage that the wheel brake device can be or is particularly easily supplied with hydraulic medium.

According to a preferred development of the present invention, it is provided that the second actuating element is designed as a brake caliper with at least a second hydraulic piston. The design of the second actuating element as a brake caliper with a hydraulic piston has the advantage that the wheel brake device can be or is particularly easily supplied with hydraulic medium.

Particularly preferably, according to an example embodiment of the present invention, it is provided that the brake force generator comprises a first hydraulic piston, which is assigned an electric actuator for controlling said hydraulic piston. The electrically controllable hydraulic piston has the advantage that the brake force generator builds up hydraulic pressure particularly simply and accurately.

According to a preferred development of the present invention, it is provided that the first hydraulic piston and the electric actuator are operatively connected to one another by a planetary gear train and/or a spindle assembly. The planetary gear train and the spindle assembly advantageously ensure particularly efficient force transmission.

Particularly preferably, according to an example embodiment of the present invention, it is provided that the actuator comprises an electric machine, in particular a direct current machine (DC motor) or an electrically commutated machine (EC/BLDC motor). Such a design of the actuator with an electric machine has the advantage that the brake force generator is controllable particularly accurately. Due to the low load requirement outlined above of the wheel brake module according to the present invention, a direct current machine can in particular be used advantageously instead of an otherwise customary, electrically commutated machine.

According to a preferred development of the present invention, it is provided that an electronic control system with a bridge circuit of the electrically commutated machine can be or is arranged on the machine or outside the wheel brake module and is connected to the machine by lines. The commutation of the electric machine is thus carried out decentrally directly on the machine or centrally. Arranging the electronic control system on the machine advantageously ensures that, as a common module, it has a particularly compact structure. Arranging the electronic control system outside the machine advantageously allows the electronic control system to be flexibly arranged in the motor vehicle. Depending on the spatial arrangement of the wheel brake module, the unsprung mass of the wheel brake module is also advantageously reduced. This is in particular possible because, as described above, the electric machine only needs to provide low electrical power and only low electrical currents are therefore transmitted via the corresponding lines between the machine and the electronic control system. In particular, the electronic control system is integrated into a control device.

The brake system according to an example embodiment of the present invention includes at least one wheel brake module according to the present invention. This results in the aforementioned advantages. In particular, the brake system comprises further wheel brake modules according to the present invention, preferably exclusively or in combination with electromechanical wheel brake modules.

It is particularly preferably provided that the brake system according to an example embodiment of the present invention comprises a control device specially configured to control the wheel brake module. This has the advantage that any combination of wheel brake modules can be controlled and coordinated as described above. In particular, a common control device is provided for all wheel brake modules.

The motor vehicle according to an example embodiment of the present invention includes the brake system according to the present invention. This, too, results in the aforementioned advantages.

According to a preferred development of the present invention, it is provided that the wheel brake module is arranged completely in the unsprung mass of the motor vehicle. This advantageously ensures that the wheel brake module has a particularly compact and space-saving structure. Alternatively, at least one component of the wheel brake module is installed in the sprung mass.

It is particularly preferably provided that the brake system comprises four wheel brake modules according to the present invention, each assigned to exactly one of four wheels of the motor vehicle. By means of the wheel brake modules, a separate, independent brake circuit is advantageously assigned to each wheel of the motor vehicle. As described above, the wheel brake modules do not require an external hydraulic connection, but need to be connected to a higher-level control logic only for controlling.

Further preferred features and combinations of features result from what is disclosed herein. The present invention is explained in more detail below with reference to the figures.

### BRIEF DESCRIPTION OF THE DRAWINGS

The FIGURE “Fig.” shows an advantageous wheel brake module of a brake system, according to an example embodiment of the present invention.

### DETAILED DESCRIPTION OF EXAMPLE EMBODIMENTS

The FIGURE shows a wheel brake module 20 of a brake system of a motor vehicle otherwise not shown in more detail. The wheel brake module 20 comprises a, in the present case exactly one, actuatable wheel brake device 21 for decelerating the motor vehicle. The wheel brake module 20 further comprises a, in the present case exactly one, controllable electromechanical brake force generator 22.

The brake force generator 22 is designed to feed hydraulic fluid into a hydraulic brake circuit in order to generate brake pressure at the wheel brake device 21. The wheel brake module 20 comprises the hydraulic brake circuit as a hydraulically closed brake circuit such that the brake circuit is assigned only to the wheel brake module 20.

The brake force generator 22 comprises a first hydraulic piston 1. The wheel brake device 21 comprises a brake caliper 23 with at least a second hydraulic piston 14. In the present case, a surface ratio of an end face of the second hydraulic piston 14 to the first hydraulic piston 1 is at least 3 to 1, 5 to 1, or 10 to 1. The brake force generator 22 and the wheel brake device 21 are fluidly connected to one another via a hydraulic line 13.

The first hydraulic piston 1 as a first actuating element and the brake caliper 23 are operatively connected to the second hydraulic piston 14 as a second actuating element by a connecting element 10 within the hydraulic line 13 such that the wheel brake device 21 is not actuated in a rest position of the first hydraulic piston 1. In the present case, the connecting element 10 is designed as a pull cable, in particular a plastic-coated metal cable, for example a Bowden cable.

The connecting element 10 provides for active retraction and thus ensures that there is no longer any contact between a brake pad of the brake caliper 23 and a brake disk 24 of the wheel brake device 21 in the rest position of the first hydraulic piston 1 of the brake force generator 22. It is guided via guide elements 12 in the hydraulic line 13 and has exactly the length that is needed to ensure, in the rest position of the hydraulic piston 1, that there is no longer any contact between the brake pads and the brake disk 24 in every case of tolerance of the brake caliper 23.

For controlling the first hydraulic piston 1, it is assigned an electric actuator comprising an electric machine 3. In the present case, the electric machine 3 is designed as an electrically commutated machine. Alternatively, it is designed as a direct current machine. The electric machine 3 comprises a rotor position sensor 25 with a magnetic wheel 7 arranged on an output shaft 6 of the electric machine 3. The magnetic wheel 7 is arranged directly below an ASIC that is necessary for scanning and mounted on a printed circuit board 8. In addition, a motor current sensor 26 is also assigned to the electric machine 3.

In the present case, an electronic control system 9 containing the printed circuit board 8 is also arranged with a bridge circuit of the electrically commutated machine on the machine 3; in particular, the electronic control system and the electric machine 3 form a structural unit. Alternatively, the electronic control system 9 is arranged outside the wheel brake module 20 and connected to the machine 3 by lines.

Furthermore, a control device 18 is provided, which is connected to the electronic control system 9 by lines and is in particular also designed to control the wheel brake module 20 or multiple wheel brake modules 20 and to detect a braking request of a driver. Alternatively, the electronic control system 9 is integrated into the control device 18.

The first hydraulic piston 1 and the electric machine 3 are operatively connected to one another by a planetary gear train 5 and a spindle screw drive or a spindle assembly 2. The first hydraulic piston 1 is displaceably mounted in a valve housing 4, within which the hydraulic piston 1 seals off a pressure chamber 19.

For regulating the pressure, a pressure sensor 11 is arranged on the pressure side of the hydraulic piston 1. However, this is optional. If the pressure building up in the system can be estimated with a model via the electrical currents that occur in the electric machine 3 when the opposing force to the hydraulic piston 1 is building up, the pressure sensor can be dispensed with.

A sealing element 17 is arranged between the hydraulic piston 1 and the valve housing. The sealing element 17 ensures that the hydraulic, high-temperature-resistant, one-time oil filling in the pressure chamber 19 and on the way to the wheel brake device 21 in the hydraulic line 13 remains enclosed as part of a hydraulic brake circuit.

A bore 15 in the valve housing 4, in which a further sealing element 16 is arranged, provides venting of the volume to an outside of the valve housing 4 when the first hydraulic piston 1 moves. The sealing element 16 is in particular designed to make the exchange of air flows possible but otherwise to seal outward in order to prevent oil leakage to the outside.

1-15. (canceled)

16. A wheel brake module of a brake system of a motor vehicle, the wheel brake module comprising:
an actuatable wheel brake device configured to decelerate the motor vehicle; and
a controllable electromechanical brake force generator;
wherein the brake force generator is configured to feed hydraulic fluid into a hydraulic brake circuit to generate brake pressure at the wheel brake device, and
wherein the wheel brake module includes the hydraulic brake circuit as a hydraulically closed brake circuit such that the brake circuit is assigned only to the wheel brake module.

17. The wheel brake module according to claim 16, wherein the actuatable wheel brake device includes exactly one actuatable wheel brake device and the controllable electromechanical brake force generator includes exactly one controllable electromechanical brake force generator.

18. The wheel brake module according to claim 16, wherein the brake force generator includes a first hydraulic piston, and the wheel brake device further comprises at least a second hydraulic piston, and a surface ratio of an end face of the second hydraulic piston to the first hydraulic piston is at least 3 to 1.

19. The wheel brake module according to claim 16, wherein a first actuating element of the brake force generator and a second actuating element of the wheel brake device are operatively connected to one another by a connecting element such that the wheel brake device is not actuated in a rest position of the first actuating element.

20. The wheel brake module according to claim 19, wherein the connecting element is a pull cable.

21. The wheel brake module according to claim 20, wherein the pull cable is a plastic-coated metal cable.

22. The wheel brake module according to claim 20, wherein the pull cable is a Bowden cable.

23. The wheel brake module according to claim 19, wherein the first actuating element is a first hydraulic piston.

24. The wheel brake module according to claim 19, wherein the second actuating element is a brake caliper with at least a second hydraulic piston.

25. The wheel brake module according to claim 16, wherein the brake force generator includes a first hydraulic piston, which is assigned an electric actuator for controlling the hydraulic piston.

26. The wheel brake module according to claim 25, wherein the first hydraulic piston and the electric actuator are operatively connected to one another by a planetary gear train and/or a spindle assembly.

27. The wheel brake module according to claim 25, wherein the actuator includes an electric machine including a direct current machine or an electrically commutated machine.

28. The wheel brake module according to claim 27, wherein an electronic control system: (i) is arranged with a bridge circuit of the electrically commutated machine on the electric machine or (ii) outside the wheel brake module and is connected to the machine by lines.

29. A brake system of a motor vehicle, comprising:
at least one wheel brake module, each including:
an actuatable wheel brake device configured to decelerate the motor vehicle; and
a controllable electromechanical brake force generator;
wherein the brake force generator is configured to feed hydraulic fluid into a hydraulic brake circuit to generate brake pressure at the wheel brake device, and
wherein the wheel brake module includes the hydraulic brake circuit as a hydraulically closed brake circuit such that the brake circuit is assigned only to the wheel brake module.

30. The brake system according to claim 29, further comprising at least one control device specifically configured to control the wheel brake module.

31. A motor vehicle, comprising:
a brake system including:
at least one wheel brake module, each including:
an actuatable wheel brake device configured to decelerate the motor vehicle; and
a controllable electromechanical brake force generator;
wherein the brake force generator is configured to feed hydraulic fluid into a hydraulic brake circuit to generate brake pressure at the wheel brake device, and
wherein the wheel brake module includes the hydraulic brake circuit as a hydraulically closed brake circuit such that the brake circuit is assigned only to the wheel brake module.

32. The motor vehicle according to claim 31, wherein the wheel brake module is completely arranged in an unsprung mass of the motor vehicle.

33. The motor vehicle according to claim 31, wherein the brake system includes four wheel brake modules, each assigned to exactly one of four wheels of the motor vehicle.
